(19) United States
(12) Patent Application Publication
(10) Pub. No.: US 2010/0124167 A1
(43) Pub. Date: May 20, 2010

(54) VIDEO PROCESSOR AND VIDEO PROCESSING METHOD THEREOF

(75) Inventor: Tatsuo Yamaguchi, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/487,415

(22) Filed: Jun. 18, 2009

(30) Foreign Application Priority Data
Nov. 20, 2008 (JP) 2008-297176

(51) Int. Cl. H04L 12/26; G06F 15/16

(52) U.S. Cl. 370/241; 709/231

(57) ABSTRACT

According to one embodiment, a video processor plays back streaming data while receiving the streaming data via wireless communication from a server which simultaneously transmits the same streaming data to a plurality of devices in a group. The video processor includes a wireless communication module, a playback module, a monitor, and a controller. The wireless communication module has power saving mode in which wireless communication function is turned on/off at predetermined intervals, and performs wireless communication while the wireless communication function is ON. The playback module performs processing to participate in the group, and plays back streaming data from the server while receiving the streaming data when the video processor participates in the group. The monitor monitors the processing performed by the playback module to participate in the group. The controller cancels the power saving mode when the monitor detects that the processing is performed to participate in the group.

### CROSS-REFERENCE TO RELATED APPLICATIONS

This application is based upon and claims the benefit of priority from Japanese Patent Application No. 2008-297176, filed Nov. 20, 2008, the entire contents of which are incorporated herein by reference.

### BACKGROUND OF THE INVENTION

1. Field

One embodiment of the invention relates to a video processor that reproduces multimedia data received via wireless communication from a server, and a video processing method thereof.

2. Description of the Related Art

The Internet protocol television (IPTV) service is one of video distribution services to distribute streaming data of high image quality video. The IPTV service is provided on a high-quality, flexible network that offers security as, for example, a next generation network (NGN). Accordingly, in a network environment, such as a wireless local area network (LAN), where packet loss occurs frequently, the streaming data cannot be adequately reproduced in the IPTV service.

Especially, carrier sense multiple access/collision avoidance (CSMA/CA) is used to transmit streaming data over a wireless LAN, and this in principle necessitates the occurrence of packet loss. Further, according to the multicast frames transmission technology based on the IEEE 802.11 wireless LAN standard, there is no mechanism to retransmit a wireless medium access control (MAC) layer. Therefore, a notebook PC, which receives streaming data using a wireless LAN chip with power saving (PS) mode in need of saving power, cannot receive streaming data from an access point (AP) while in PS mode.

In view of this, Japanese Patent Application Publication (KOKAI) No. 2007-288639 discloses a method for controlling Quality of service (QoS) in PS mode. According to the method, an AP transmits data only after the transmission of beacon signals in a cycle n times as long as the cycle of transmitting the beacon signals. A notebook PC shifts from sleep mode to awake mode in the cycle of receiving the beacon signals. Thus, the notebook PC can maintain the reception quality of streaming data transmitted via multicast communication.

With the above method for controlling the communication quality of power-saving wireless LAN, both the AP and the notebook PC are required to change the cycle of transmitting/receiving data. That is, even if only the notebook PC change the cycle, the reception quality of streaming data cannot be ensured.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a notebook PC according to an embodiment of the invention;

FIG. 2 is an exemplary block diagram of software modules in the embodiment;

FIG. 3 is an exemplary functional block diagram of the notebook PC in the embodiment;

FIG. 4 is an exemplary sequence diagram of the process of receiving streaming data in the embodiment;

FIG. 5 is an exemplary block diagram of software modules according to a first modification of the embodiment; and

FIG. 6 is an exemplary block diagram of software modules according to a second modification of the embodiment.

### DETAILED DESCRIPTION

Various embodiments according to the invention will be described hereinafter with reference to the accompanying drawings. In general, according to one embodiment of the invention, a video processor plays back streaming data while receiving the streaming data via wireless communication from a server which simultaneously transmits the same streaming data only once to a plurality of devices participating in a group. The video processor comprises a wireless communication module, a playback module, a monitor, and a controller. The wireless communication module is provided with power saving mode in which wireless communication function is turned on and off repeatedly at predetermined intervals, and is configured to perform wireless communication while the wireless communication function is ON. The playback module is configured to perform processing to participate in the group through the wireless communication module, and play back streaming data transmitted from the server while receiving the streaming data when the video processor participates in the group. The monitor is configured to monitor the processing performed by the playback module to participate in the group. The controller is configured to cancel the power saving mode of the wireless communication module when the monitor detects that the processing is performed to participate in the group.

According to another embodiment of the invention, a video processor comprises a wireless communication module, a playback module, and a controller. The wireless communication module is provided with power saving mode in which wireless communication function is turned on and off repeatedly at predetermined intervals, and is configured to perform wireless communication while the wireless communication function is ON. The playback module is configured to play back streaming data transmitted from a server while receiving the streaming data through the wireless communication module. The controller is configured to cancel the power saving mode of the wireless communication module when the playback module starts reproducing the streaming data.

According to still another embodiment of the invention, there is provided a video processing method applied to a video processor that plays back streaming data while receiving the streaming data via wireless communication from a server which transmits the same streaming data to a plurality of devices participating in a group. The video processor comprises a wireless communication module that is provided with power saving mode in which wireless communication function is turned on and off repeatedly at predetermined intervals and that is configured to perform wireless communication while the wireless communication function is ON. The video processing method comprises: a playback module performing processing to participate in the group through the wireless communication module, and playing back streaming data transmitted from the server while receiving the streaming data when the video processor participates in the group; a monitor monitoring the processing performed by the playback module to participate in the group; and a controller cancelling the power saving mode of the wireless communication module when the monitor detects that the processing is performed to participate in the group.

In the following, a video processor and a video processing method thereof according to the embodiments are described as being applied to a notebook personal computer (PC). However, this is byway of example and not byway of limitation. The video processor and the video processing method thereof may be applied to any device that reproduces streaming data while receiving the streaming data via wireless communication from a server which simultaneously transmits the same streaming data only once to a plurality of devices in a multicast group. For example, the video processor and the video processing method thereof may be applied to a hard disk drive (HDD) recorder, a desktop PC, and the like.

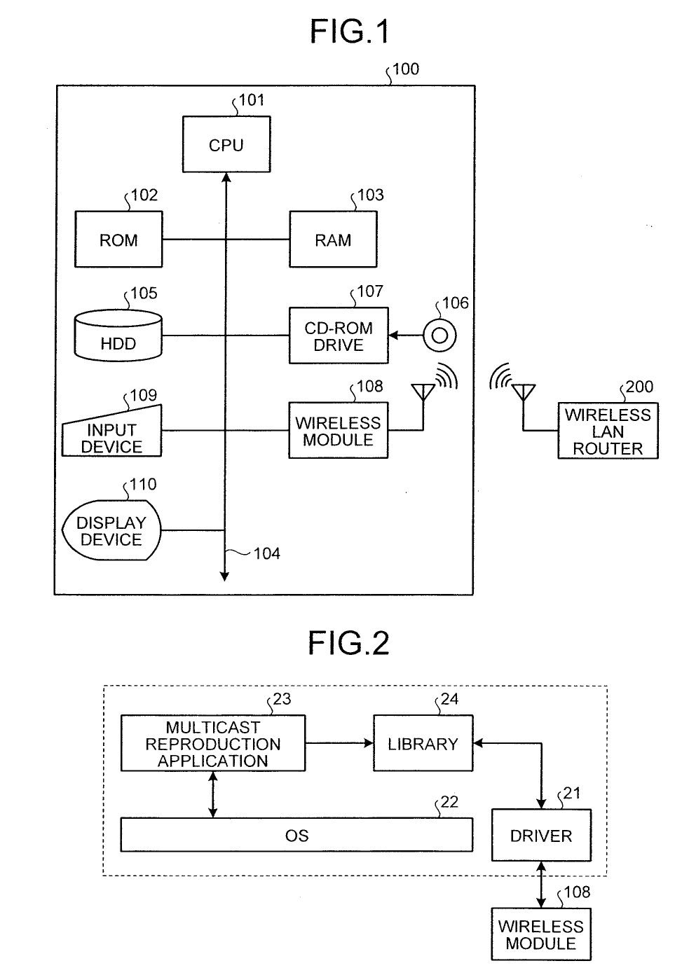

FIG. 1 is a block diagram of a notebook PC 100 according to an embodiment of the invention. As illustrated in FIG. 1, the notebook PC 100 comprises a central processing unit (CPU) 101, a read only memory (ROM) 102, and a random access memory (RAM) 103, which are interconnected by a bus 104. The CPU 101 is a heart of the notebook PC 100 and collectively controls constituent elements of the notebook PC 100. The ROM 102 is read-only and stores a basic input/output system (BIOS) and the like, while the RAM 103 is a rewritable medium that stores various types of data in a rewritable manner.

The notebook PC 100 further comprises a hard disk drive (HDD) 105, a compact disk read-only memory (CD-ROM) drive 107, a wireless module 108, an input device 109, and a display device 110. The HDD 105 stores various programs. The CD-ROM drive 107 reads computer software, which is a distributed program, from a CD-ROM 106. The wireless module 108 controls communication between the notebook PC 100 and a wireless LAN router 200. The input device 109 includes a keyboard, a mouse, and the like used to input various instructions. The display device 110 includes a cathode ray tube (CRT) or a liquid crystal display (LCD) to display various types of information. The above modules are also interconnected by the bus 104 via an I/O (not illustrated).

The wireless module 108 performs wireless communication with the wireless LAN router 200. The wireless LAN router 200 relays streaming data (video data, audio data, etc.) between the notebook PC 100 and a server. The server simultaneously transmits the same streaming data only once to a plurality of devices participating in an IPv6 multicast group based on IPv6. The wireless module 108 may be, for example, a wireless LAN chip compliant with the IEEE 802.11 standard.

In addition, the wireless module 108 operates in IEEE 802.11 power saving mode, in which wireless transmission/reception function is turned on/off repeatedly at predetermined intervals. While the wireless transmission/reception function is ON, the wireless module 108 performs wireless communication with the wireless LAN router 200. It is assumed herein that the power saving mode is activated/canceled by rewriting a set value stored in a register of the wireless module 108. Incidentally, while the power saving mode is OFF, the wireless transmission/reception function is generally always ON, and wireless communication is possible.

Since the RAM 103 stores various types of data in a rewritable manner, it provides a work area to the CPU 101 and functions as a buffer or the like.

The CD-ROM 106 stores an operating system (OS) and various programs. The CD-ROM drive 107 reads the programs from the CD-ROM 106 under the control of the CPU 101. Then, the programs are installed on the HDD 105.

While the CD-ROM 106 is cited above as an example of a storage medium of the embodiment, the storage medium may be of different types. Examples of the storage medium of the embodiment include various types of optical disks such as a digital versatile disk (DVD), various types of magneto-optical discs, various types of magnetic disks such as a flexible disk (FD), and semiconductor memory. Alternatively, the programs may be downloaded via a network such as the Internet through the wireless module 108 and installed on the HDD 105. In this case, a storage device of a sender server that stores the programs can be regarded as the storage medium of the embodiment. Incidentally, the programs may run on a predetermined OS and, in this case, the OS may perform part of various types of processing implemented by the programs, which will be described later. Further, the programs may be stored as part of a group of program files that constitutes predetermined application software, the OS, or the like.

The CPU 101 controls the overall operation of the system, and performs various types of processing based on the programs loaded into the HDD 105 used as the main storage device of the system.

With reference to FIG. 2, a description will now be given of software modules of a program loaded into the HDD 105. FIG. 2 is a block diagram of the software modules.

The software modules include a driver 21, an OS 22, a multicast reproduction application 23, and a library 24. The OS 22 is basic software that is installed on a host such as, for example, Windows (registered trade mark). The multicast reproduction application 23 is software that runs on the OS 22, and performs processing such as to transmit/receive MLDv2 packets to/from the wireless LAN router 200, to reproduce streaming data contained in an MLDv2 packet, and to provide the driver 21, which will be described later, with an application programming interface (API) stored in the library 24, which will be described later. The library 24 is a dynamic link library (DLL) that runs on the OS 22, and stores the API to be provided to the driver 21 in response to a call from the multicast reproduction application 23. The driver 21 is software that controls the wireless module 108. More specifically, according to the API provided by the library 24, the driver 21 controls the activation/cancellation of the power saving mode of the wireless module 108.

A description will then be given of a salient function of the notebook PC 100 among those implemented by the software modules illustrated in FIG. 2.

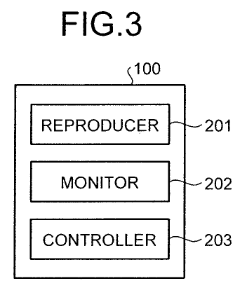

FIG. 3 is a functional block diagram of the notebook PC 100 according to the embodiment. As illustrated in FIG. 3. the notebook PC 100 comprises a reproducer 201 (playback module), a monitor 202, and a controller 203.

The reproducer 201 is implemented by the multicast reproduction application 23, and performs processing to join in an IPv6 multicast group through the wireless module 108. More specifically, the reproducer 201 receives in advance reproduction information for each channel to reproduce streaming data contained in an MLDv2 packet (or an MLDv1 packet) transmitted from the server. Examples of the reproduction information include the address of the server, a multicast address to specify the IPv6 multicast group, and the number of a port from which streaming data is to be received. Based on the reproduction information, the reproducer 201 transmits an MLDv2 packet (or an MLDv1 packet) to inquire whether the notebook PC 100 can participate in the IPv6 multicast group, i.e., to request for participation in the IPv6 multicast group.

While, in the embodiment, an MLDv2 packet (or an MLDv1 packet) is transmitted to inquire whether the notebook PC 100 can participate in an IPv6 multicast group, this is by way of example and not of limitation. It suffices if an inquiry can be made as to participation in a group. For example, in the case where the server simultaneously transmits streaming data via multicast to a plurality of devices participating in an IPv4 multicast group based on IPv4, the reproducer 201 transmits an Internet group management protocol (IGMP) packet to inquire whether the notebook PC 100 can participate in the IPv4 multicast group.

Upon receipt of an MLDv2 packet transmitted from the server through the wireless module 108, which notifies the reproducer 201 that the notebook PC 100 participates in the IPv6 multicast group, the reproducer 201 receives streaming data transmitted from the server and, at the same time, reproduces the streaming data while the notebook PC 100 participates in the IPv6 multicast group.

Besides, the reproducer 201 performs processing to leave the IPv6 multicast group through the wireless module 108. More specifically, based on the reproduction information received in advance, the reproducer 201 transmits an MLDv2 packet (or an MLDv1 packet) to request to remove the notebook PC 100 from the IPv6 multicast group.

While, in the embodiment, an MLDv2 packet (or an MLDv1 packet) is transmitted to request to remove the notebook PC 100 from an IPv6 multicast group, this is by way of example and not of limitation. It suffices if a request can be made to leave a group. For example, in the case where the server transmits streaming data via multicast to a plurality of devices participating in an IPv4 multicast group based on IPv4, the reproducer 201 transmits an IGMP packet to leave the IPv4 multicast group.

The monitor 202 is implemented by the multicast reproduction application 23, and monitors the processing performed by the reproducer 201 to participate in an IPv6 multicast group. More specifically, the monitor 202 monitors the transmission of an MLDv2 packet (or an MLDv1 packet) by the reproducer 201 to inquire whether the notebook PC 100 can participate in the IPv6 multicast group.

Besides, the monitor 202 monitors the processing performed by the reproducer 201 to leave the IPv6 multicast group. More specifically, the monitor 202 monitors the transmission of an MLDv2 packet (or an MLDv1 packet) by the reproducer 201 to request to remove the notebook PC 100 from the IPv6 multicast group.

The controller 203 is implemented by the multicast reproduction application 23, the library 24, and the driver 21, and controls the wireless module 108 to operate. More specifically, when the monitor 202 detects that the processing is performed to participate in an IPv6 multicast group, the controller 203 rewrites the set value stored in the register of the wireless module 108 to cancel the power saving mode of the wireless module 108.

Besides, when the monitor 202 detects that the processing is performed to leave the IPv6 multicast group, the controller 203 rewrites the set value stored in the register of the wireless module 108 so that the wireless module 108 enters the power saving mode.

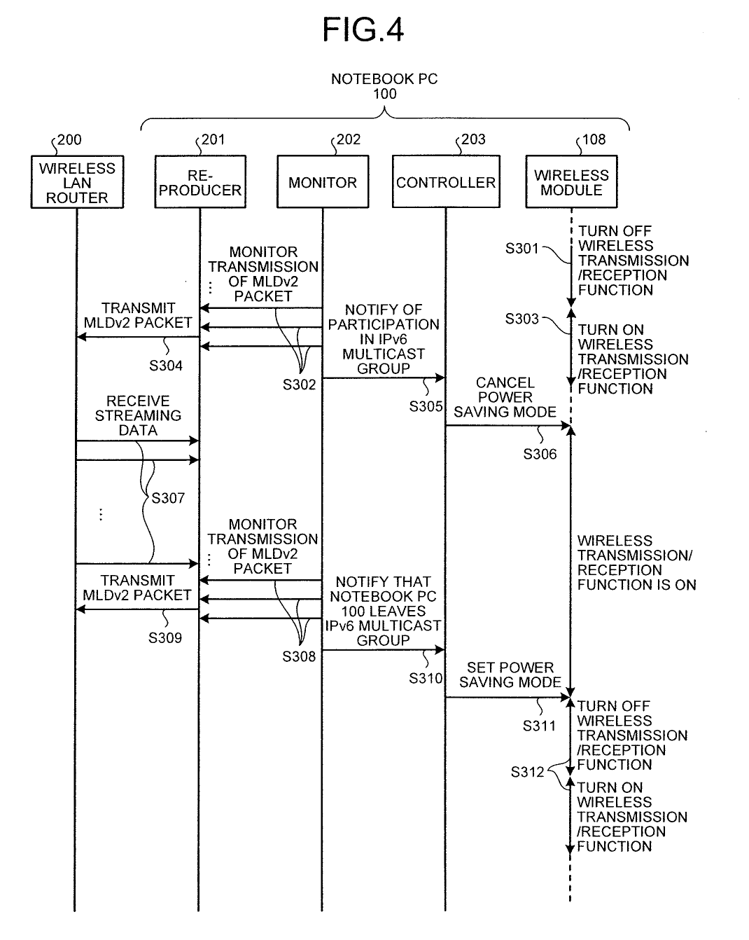

With reference to FIG. 4, a description will now be given of the process of receiving streaming data performed by the notebook PC 100. FIG. 4 is a sequence diagram of the process of receiving streaming data.

Before receiving streaming data, the wireless module 108 repeatedly turns on/off the wireless transmission/reception function at predetermined intervals through the power saving mode (S301).

The monitor 202 monitors the transmission of an MLDv2 packet by the reproducer 201 to inquire whether the notebook PC 100 can participate in an IPv6 multicast group, i.e., to request for participation in an IPv6 multicast group (S302). When the wireless transmission/reception function of the wireless module 108 is turned on (S303), the reproducer 201 transmits an MLDv2 packet to inquire whether the notebook PC 100 can participate in an IPv6 multicast group, i.e., to request for participation in an IPv6 multicast group, to the wireless LAN router 200 via the wireless module 108 (S304).

After the reproducer 201 transmits the MLDv2 packet, the monitor 202 notifies the controller 203 of participation in the IPv6 multicast group (S305). Having notified by the monitor 202 of participation in the IPv6 multicast group, the controller 203 cancels the power saving mode of the wireless module 108 (S306).

Upon receipt of an MLDv2 packet that notifies the reproducer 201 that the notebook PC 100 participates in the IPv6 multicast group after the controller 203 cancels the power saving mode of the wireless module 108, the reproducer 201 starts receiving streaming data as well as reproducing the streaming data (S307). At this point, since the power saving mode of the wireless module 108 is cancelled and the wireless transmission/reception function is ON, communication can be prevented from being interrupted.

While the reproducer 201 is receiving streaming data, the monitor 202 monitors the transmission of an MLDv2 packet by the reproducer 201 to request to remove the notebook PC 100 from the IPv6 multicast group (S308). When the reproducer 201 transmits an MLDv2 packet to request to remove the notebook PC 100 from the IPv6 multicast group (S309), the monitor 202 notifies the controller 203 that the notebook PC 100 leaves the IPv6 multicast group (S310).

Having notified by the monitor 202 that the notebook PC 100 leaves the IPv6 multicast group, the controller 203 sets the wireless module 108 to the power saving mode (S311). While in the power saving mode, the wireless module 108 repeatedly turns on/off the wireless transmission/reception function at predetermined intervals (S312).

As described above, according to the embodiment, when the processing is performed to participate in an IPv6 multicast group, the power saving mode of the wireless module 108 is canceled. With this, the wireless transmission/reception function of the wireless module 108 can be prevented from being turned off while streaming data is received. Thus, it is possible to maintain the power saving effect of the power saving mode and also to ensure the reception quality of multicast streaming data by changing only the settings of the notebook PC 100.

While the embodiment has been described above on the assumption that streaming data is transmitted via multicast, this is by way of example and not of limitation. For example, the power saving mode may be canceled while streaming data is received via video on demand (VoD) unicast. In this case, for example, the monitor 202 monitors a streaming data reproduction application (the reproducer 201) that initiates/terminates reproduction of streaming data. According to the initiation/termination of reproduction of streaming data by the reproduction application, the power saving mode is switched between ON and OFF.

A first modification of the embodiment will be described. A notebook PC of the first modification is different in software module configuration from the notebook PC 100 of the above embodiment, and achieves the same functions as that of the notebook PC 100. Software modules of the first modification are basically similar to those of the above embodiment, and therefore, only the difference will be described rather than repeating the same description.

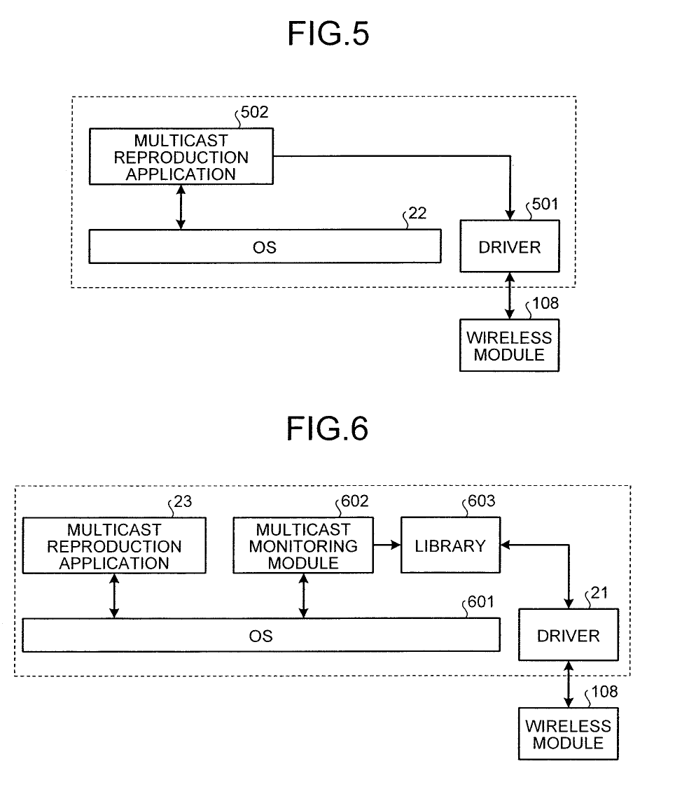

FIG. 5 is a block diagram of the software modules of the notebook PC according to the first modification. Differently from the software modules of the notebook PC 100 of the above embodiment, the software modules of the first modification include a driver 501 and a multicast reproduction application 502 that perform different functions than the driver 21 and the multicast reproduction application 23, respectively.

The multicast reproduction application 502 is software that runs on the OS 22, and performs processing such as to transmit/receive MLDv2 packets to/from the wireless LAN router 200, to reproduce streaming data contained in an MLDv2 packet, and to call the API provided to the driver 501. The driver 501 is software that controls the wireless module 108 in response to a call for the API from the multicast reproduction application 502. According to the API called by the multicast reproduction application 502, the driver 501 controls the activation/cancellation of the power saving mode of the wireless module 108.

Incidentally, in the first modification, the reproducer 201 and the monitor 202 illustrated in FIG. 3 are implemented by the multicast reproduction application 502, while the controller 203 illustrated in FIG. 3 is implemented by the driver 501 and the multicast reproduction application 502.

As described above, according to the first modification, the same function as that of the notebook PC 100 of the above embodiment can be implemented. Thus, the same effect as that of the above embodiment can be achieved.

A second modification of the embodiment will be described. A notebook PC of the second modification is different in software module configuration from the notebook PC 100 of the above embodiment, and achieves the same functions as that of the notebook PC 100. Software modules of the second modification are basically similar to those of the above embodiment, and therefore, only the difference will be described rather than repeating the same description.

FIG. 6 is a block diagram of the software modules of the notebook PC according to the second modification. Differently from the software modules of the notebook PC 100 of the above embodiment, the software modules of the second modification include an OS 601 and a library 603 that perform different functions than the OS 22 and the library 24, respectively. In addition, the software modules of the second modification further include a multicast monitoring module 602.

The OS 601 is basic software, and stores a transmission management table on which is recorded the history (transmission history) of the transmission of MLDv2 packets (or MLDv1 packets) by the multicast reproduction application 23. The multicast monitoring module 602 is software that runs on the OS 601. The multicast monitoring module 602 performs processing such as to monitor the processing performed by the multicast reproduction application 23 to participate in an IPv6 multicast group based on the transmission history recorded on the transmission management table stored in the OS 601, and to provide the driver 21 with the API stored in the library 603. The library 603 runs on the OS 601, and stores the API to be provided to the driver 21 in response to a call from the multicast monitoring module 602.

Incidentally, in the second modification, the reproducer 201 illustrated in FIG. 3 is implemented by the multicast reproduction application 23. Besides, the monitor 202 illustrated in FIG. 3 is implemented by the OS 601 and the multicast monitoring module 602, while the controller 203 illustrated in FIG. 3 is implemented by the multicast monitoring module 602, the library 603, and the driver 21.

As described above, according to the second modification, the same function as that of the notebook PC 100 of the above embodiment can be implemented. Thus, the same effect as that of the above embodiment can be achieved.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video processor configured to play back streaming data while receiving the streaming data via wireless communication from a server configured to simultaneously transmit identical streaming data once to a plurality of devices in a group, the video processor comprising:
a wireless communication module with a power saving mode in which wireless communication function is turned on and off at predetermined intervals, the wireless communication module configured to perform wireless communication while the wireless communication function is on;
a playback module configured to participate in the group through the wireless communication module, and to play back streaming data transmitted from the server while receiving the streaming data when the video processor participates in the group;
a monitor configured to monitor the participation of the playback module; and
a controller configured to cancel the power saving mode of the wireless communication module when the monitor detects the participation the group.

2. The video processor of claim 1, wherein
the playback module is further configured to transmit a participation request packet requesting for participation in the group,
the monitor is configured to monitor transmission of the participation request packet by the playback module, and
the controller is configured to cancel the power saving mode of the wireless communication module when the monitor detects the transmission of the participation request packet.

3. The video processor of claim 1, wherein
the playback module is configured to quit from the group,
the monitor is configured to monitor the playback module's quitting from the group, and
the controller is configured to set the wireless communication module to the power saving mode when the monitor detects the quitting the group.

4. The video processor of claim 3, wherein
the playback module is further configured to transmit a removal request packet requesting a removal the video processor from the group,
the monitor is configured to monitor transmission of the removal request packet by the playback module, and
the controller is configured to set the wireless communication module to the power saving mode when the monitor detects the transmission of the removal request packet.

5. A video processor comprising:
a wireless communication module with a power saving mode in which wireless communication function is turned on and off at predetermined intervals, the wireless communication module configured to perform wireless communication while the wireless communication function is on;
a playback module configured to play back streaming data transmitted from a server while receiving the streaming data through the wireless communication module; and
a controller configured to cancel the power saving mode of the wireless communication module when the playback module starts reproducing the streaming data.

6. The video processor of claim 5, wherein the controller is configured to set the wireless communication module to the power saving mode when the playback module terminates reproduction of the streaming data.

7. A video processing method applied to a video processor configured to play back streaming data while receiving the streaming data via wireless communication from a server configured to transmit identical streaming data to a plurality of devices in a group, wherein the video processor comprises a wireless communication module with a power saving mode in which wireless communication function is turned on and off at predetermined intervals, the wireless communication module configured to perform wireless communication while the wireless communication function is on, the video processing method comprising:
participating in the group through the wireless communication module, and playing back streaming data transmitted from the server while receiving the streaming data when the video processor participates in the group;
monitoring the participating in the group; and
cancelling the power saving mode of the wireless communication module when the monitor detects the participation in the group.
